(19) United States
(12) Patent Application Publication
(10) Pub. No.: US 2006/0130919 A1
(43) Pub. Date: Jun. 22, 2006

(54) Device for attenuating pressure oscillations in hydraulic lines

(76) Inventors: Werner Ehmann, Stuttgart (DE); Oliver Essig, Winnenden (DE); Herbert Guettler, Elchingen (DE); Marco Maier, Giessen (DE); Michael Rapp, Sussen (DE); Wilhelm Schiffer, Markgronigen (DE); Silvia Tomaschko, Ulm (DE)

Correspondence Address: KLAUS J. BACH, 4407 TWIN OAKS DRIVE, MURRYSVILLE, PA, 15668, US

(21) Appl. No.: 11/249,012

(22) Filed: Oct. 12, 2005

Related U.S. Application Data
(63) Continuation-in-part of application No. PCT/EP04/03214, filed on Mar. 26, 2004.

(30) Foreign Application Priority Data
Apr. 12, 2003 (DE) 103 16 946.6

(51) Int. Cl. F16L 55/04

(52) U.S. Cl. 138/30; 138/26; 181/161

(57) ABSTRACT

In a device for attenuating pressure oscillations in a hydraulic line, wherein an actuator for generating pressure pulses in the hydraulic line is arranged between a pressure source and a consumer, a control apparatus is provided for activating the actuator in such a way that it generates pressure pulses which are at least approximately in antiphase to pressure oscillations detected in the hydraulic line, which pressure oscillations are detected by a sensor in the hydraulic line or determined by the control apparatus depending on parameters of the pressure source for controlling the pressure pulses applied to the hydraulic line.

This is a Continuation-In-Part application of International application PCT/EP2004/003214 filed Mar. 26, 2003 and claiming the priority of German application 103 16 946.6 filed Apr. 12, 2003.

### BACKGROUND OF THE INVENTION

The invention relates to a device for attenuating pressure oscillations in a hydraulic line between a pressure source and a consumer by the generation of anti-phase pressure oscillations.

In a hydraulic system, a pump constitutes a sound source which, in the case of a vane-cell pump for example, emits pressure pulses into the hydraulic system via the pipes, or the liquid column under pressure. The pressure pulses occur when pressure change processes take place which cannot be eliminated completely by purely constructional actions on the vane-cell pump. Energy-absorbing hydraulic lines are therefore usually provided between pump and consumer. While pressure pulses can be weakened with such passive attenuation, this attenuation nevertheless usually takes place optimally only during operation of the pump.

A device in which pressure oscillations in a pipe are detected via sensors and counter-oscillations are generated via a vibration element is known from WO 95/24171. This is intended to reduce the pressure oscillations in the pipe.

It is the object of the present invention to provide a device for attenuating pressure oscillations in hydraulic lines, which is simple and can be used even in existing hydraulic line systems.

### SUMMARY OF THE INVENTION

In a device for attenuating pressure oscillations in a hydraulic line, wherein an actuator for generating pressure pulses in the hydraulic line is arranged between a pressure source and a consumer, a control apparatus is provided for activating the actuator in such a way that it generates pressure pulses which are at least approximately in antiphase to pressure oscillations detected in the hydraulic line, which pressure oscillations are detected by a sensor in the hydraulic line or determined by the control apparatus depending on parameters of the pressure source for controlling the pressure pulses applied to the hydraulic line.

The basic idea of the invention is to generate pressure pulses in the hydraulic line by an actuator which is operated with the same amplitude as, and in antiphase to, oscillations which are emitted by the pressure source and are present in the hydraulic line. When the different pressure oscillations and pressure pulses meet, superposition occurs, by virtue of which, in ideal circumstances, the oscillation is eliminated (anti-noise principle).

For this purpose, a control circuit consisting of a pressure sensor and an actuator and also a control apparatus is provided, which apparatus can evaluate the pressure oscillations detected and activate the actuator accordingly. In this connection, the sensor and the actuator are arranged in such a way in a hydraulic line between a pressure source and a consumer that the actuator has a smaller distance from the pressure source than the sensor does. This ensures that an oscillation occurring at the consumer is detected and pressure pulses corresponding to the detected oscillations are introduced into the hydraulic line via by the control apparatus and the actuator so as to cancel the oscillations.

As an alternative or in addition to the detection of the pressure fluctuation emitted by the pressure source, parameters of the pressure source, depending on which the actuator is activated, can be evaluated by the control apparatus. Relevant parameters may be the speed of a pump or of a motor of the pressure source and also temperature and/or flow rate of the hydraulic fluid, for example. Corresponding sets of characteristics, which represent for example an activating signal for the actuator depending on these parameters, are stored in the control unit.

The actuator comprises a piezoelement which is mounted in a housing attached to the hydraulic line. By converting electrical energy applied to the piezoelement into mechanical energy, the piezoelement can excite a membrane to produce oscillations, so that these can then be transmitted from the membrane to the hydraulic fluid present in the hydraulic line. In this connection, the piezoelement acts indirectly on the membrane via a linkage, so that the oscillation generated by the piezoelement can be transmitted to the membrane with its amplitude modified.

In one embodiment of the invention, the sensor is arranged inside the housing of the actuator. This makes it possible to achieve a compact construction of the device according to the invention.

The device according to the invention can in principle find application in any hydraulic circuit on which special demands are made with regard to vibrations and noise. It can be used in the servo hydraulics of steering systems of a motor vehicle, in the lubricating oil circuit of internal combustion engines, in the hydraulic system of brake assemblies or suspension systems of a motor vehicle, for example.

The invention will become more readily apparent the from the following description of exemplary embodiments thereof with reference to the accompanying drawings:

### BRIEF DESCRIPTION OF THE DRAWINGS

FIG. 1 shows diagrammatically a device according to the invention in a hydraulic system;

FIG. 2 shows the principle of the active attenuation by oscillation superposition, and

FIG. 3 shows in a cross sectional view an actuator according to the invention.

### DESCRIPTION OF A PARTICULAR EMBODIMENT

In the drawings, the same reference numbers are used for the same or similar components.

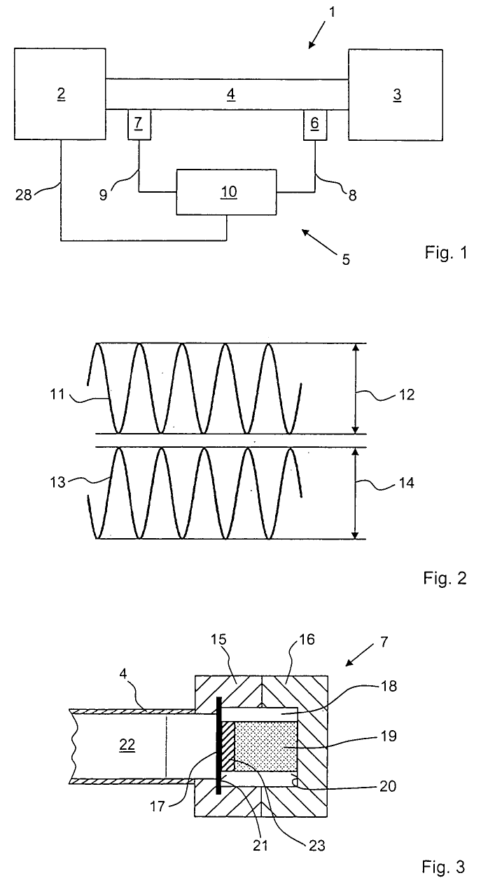

A hydraulic system 1, in which a pressure source 2, for example a vane-cell pump, is connected to a consumer 3, for example a hydraulic motor, via a hydraulic line 4, is illustrated in FIG. 1. A device 5 according to the invention is arranged between the pump 2 and the motor 3. A sensor 6 and an actuator 7 are operationally connected to the hydraulic line 4. The actuator 7 has a smaller distance to the pump 2 than the sensor 6 does. The sensor 6 and sensors (not illustrated) in or on the pressure source 2 are connected to the input of a control apparatus 10 via signal lines 8, 28. The actuator 7 is connected to an output of the control apparatus 10 via a signal line 9.

The sensor 6 detects an oscillation 11, illustrated by way of example in FIG. 2 in the upper part of FIG. 2, of a pressure wave with the amplitude 12 originating from the pressure source 2. This oscillation 11 is evaluated in the control apparatus 10. The control apparatus 10 then activates the actuator 7 via the signal line 9 in such a way that oscillations 13 are emitted into the hydraulic line 4 by the actuator 7, which, under ideal circumstances, correspond to the oscillation 13 illustrated in FIG. 2, the lower part. The emitted oscillation 13 is rotated in phase by exactly 180° in relation to the oscillation 11 detected by the sensor 6 and consequently oscillates in antiphase to it. As the amplitudes 12, 14 of the two oscillations 11, 13 are also coincident in ideal circumstances, complete superposition of the two oscillations 11, 13 and consequently complete, mutual cancellation of the oscillation 11 takes place.

The oscillation 13 illustrated in FIG. 2 to be generated by the actuator 7 can also be determined by the control unit 10 via relationships, stored in sets of characteristic connection between parameters of the pressure source and activating signals of the actuator 7.

As a result pressure oscillations no longer occur in the hydraulic line 4. By virtue of this, vibrations in the hydraulic line 4 can be reduced, which makes it possible to dispense with mechanical damping elements. Likewise, a pump with smaller capacity can be used and energy can consequently be saved. In comparison with passive damping by means of resilient hoses between pump and motor, the advantage exists that the pressure generated by the pump is not partly reduced by elastic expansion action of the resilient hoses.

FIG. 3 shows in cross section an actuator 7 according to the invention. For reasons of clarity, however, the connections to the piezoelement 19 and the signal lines leading from there to the control apparatus have not been illustrated.

In FIG. 3, an actuator 7, which comprises two axially separate housing parts 15, 16 interconnected via, for example, screw connections (not shown), is attached non-positively to one end of a hydraulic line 4. The housing parts 15, 16 and a membrane 17 supported in the housing part 15 facing the hydraulic line 4 and made for example of thin metal surround a working chamber 18 which is sealed in relation to the hydraulic line 4. A piezoelement 19, which is supported on the one hand on the inner wall 20 of the housing part 16 facing away from the hydraulic line 4 and on the other hand on the inner side 21 of the membrane 17, which faces the working chamber 18, is arranged in this working chamber 18.

A transmission element 23, which transmits a change in length of the piezoelement 19 in an amplified manner to the membrane 17, is arranged between the piezoelement 19 and the membrane 17. This transmission element 23 can be a mechanical linkage functioning according to the lever principle or a hydraulic transmission, for example.

When voltage is applied to the piezoelement 19 via for example contacts (not shown in the drawings) of the piezoelement 19, the piezoelement 19 expands by a certain amount in the longitudinal direction. The expansion amount depends on the voltage level and the shape and material composition of the piezoelement 19, for example.

Owing to the support of the piezoelement 19 on the inner wall 20 of the rear housing part 16, the change in length of the piezoelement 19 brings about, via the transmission element 23, an at least brief displacement of regions of the membrane 17 in the direction of the hydraulic fluid 22 present in the hydraulic line 4. This generates a pressure wave in the hydraulic fluid 22, which, starting from the membrane 17, is propagated in the hydraulic line 4.

The oscillation length and the amplitude 14 of the pressure wave 13 can be influenced by means of the duration of the voltage application which affects the change in length of the piezoelement 19. It is consequently possible to generate a pressure wave 13 with a predetermined oscillation profile in the hydraulic line 4 by appropriate activation of the actuator 7. The pressure wave 13 generated ideally corresponds to a pressure wave 13 of the same amplitude but in antiphase detected by the sensor 6.

Hydraulic amplification of the oscillation generated by the piezoelement 19 can be brought about, for example, by that side of the membrane 17 facing the hydraulic line 4 having a free cross-sectional area which is larger than the cross-sectional area of the hydraulic line 4. A pressure oscillation 13 emitted by the membrane 17 into the region lying directly in front of the membrane 17 is amplified by a cross-sectional contraction of the hydraulic fluid on entry into the hydraulic line 4.

Embodiments of actuators 7 in which a sensor 6 is also in each case enclosed in the working chamber 18 surrounded by the housing 15, 16 and the membrane 17 are also conceivable. The sensor 6 can be arranged between the piezoelement 19 and the membrane 17 or between piezoelement 19 and inner wall 20 of the rear housing part 16, for example.

The sensor used can, like the sensor 6 in FIG. 1, be a piezoelement. Pressure waves striking this piezoelement (sensor) bring about deformations on the piezoelement, which results in changes in voltage, which can be recognized and evaluated by the control apparatus 10.

Such a device according to the invention functions as follows:

A sensor integrated in the housing 15, 16 of the actuator 7 detects a pressure oscillation 11 present in the hydraulic line 4 and striking the membrane 17 and sends a corresponding signal to the control apparatus 10 via the line 8. The control apparatus 10 evaluates this signal and activates the piezoelement 19 of the actuator 7 to produce oscillations 13 which are transmitted via the piezoelement of the sensor to the membrane 17 and from there to the hydraulic fluid 22 in the hydraulic line 4. The oscillations 13 caused in the hydraulic fluid 22 in this connection cancel the oscillation 11 caused by the pressure source 2 owing to superposition.

It is also possible for the piezoelement of the sensor to be arranged between the piezoelement 19 of the actuator 7 and the inner wall 20 of the housing part 16 facing away from the hydraulic line 4. In this arrangement also, the oscillations detected by the sensor are made up of the pressure oscillations 11 present in the hydraulic line 4 and the oscillations 13 generated by the actuator 7, so that, to determine the pressure oscillation 13 actually originating from the hydraulic line 4, the oscillation 11 caused by the actuator is to be subtracted by the control apparatus 10.

The arrangement of a sensor in the housing 15, 16 of the actuator 7 requires only a small space because of dual uses of parts. The housing 15, 16 and the membrane 17 of the actuator 7 are used also for the sensor, for example.

What is claimed is:

1. A device (6, 7, 8, 9, 10) for attenuating pressure oscillations in a hydraulic line (4) between a pressure source (2) and a consumer (3), comprising a sensor (6) for sensing pressure oscillations in the hydraulic line (4), and an actuator connected to the hydraulic line (4) a control apparatus (10) capable of evaluating the pressure oscillations (11) detected the sensor (6) in the hydraulic line (4) and activating said actuator (7) said actuator (7) comprising a piezoelement (19) energized by the control apparatus (10) depending on parameters of the pressure source (2) in such a way that the actuator (7) generates pressure oscillations (13) in the hydraulic line (4) which are at least approximately in antiphase to the pressure oscillations (11) detected by the sensor (6), a transmission element (23) arranged between the piezoelement (19) and a membrane (17) which is acted on one side by hydraulic fluid (22) present in the hydraulic line (4), with which the amplitude (14) of an oscillation (13) of the piezoelement (19) can be amplified, said actuator (7) comprising a housing (15, 16) which is connected non-positively to the hydraulic line (4) and in which the piezoelement is supported and said piezoelement (19) having one side operatively connected to one side (21) of the membrane (17), and another side acted on by the hydraulic fluid (22) in the hydraulic line (4).

2. The device as claimed in claim 1, wherein the transmission element (23) functions according to the lever principle.

3. The device as claimed in claim 1, wherein the actuator (7) has on the side of the membrane (17) disposed opposite the piezoelement (19) a region (24) which is connected to the hydraulic line (4) and has a cross-section which is larger than the cross-section of the hydraulic line (4).

4. The device as claimed in claim 1, wherein the housing (15, 16) of the actuator (7) is separable in the longitudinal direction and attached to the hydraulic line (4) via an adapter.

5. The device as claimed in claim 1, wherein the sensor (6) and the actuator (7) are surrounded by the same housing (15, 16).
